(19) United States
(12) Patent Application Publication
(10) Pub. No.: US 2007/0086214 A1
(43) Pub. Date: Apr. 19, 2007

(54) SURFACE LIGHT SOURCE APPARATUS

(75) Inventors: Chia-Tsao Wu, Hsinchu (TW); Pan-Chih Liu, Hsinchu (TW)

Correspondence Address: J C PATENTS, INC., 4 VENTURE, SUITE 250, IRVINE, CA, 92618, US

(73) Assignee: CORETRONIC CORPORATION, Hsinchu (TW)

(21) Appl. No.: 11/530,593

(22) Filed: Sep. 11, 2006

(30) Foreign Application Priority Data
Oct. 18, 2005 (TW) 94136285

(51) Int. Cl. F21V 7/04

(52) U.S. Cl. 362/634; 362/614; 362/613

(57) ABSTRACT

A surface light source apparatus including a lamp reflector, a light guide plate, a transparent support member and a light source is provided. The lamp reflector includes a bottom surface and a light emitting cross-section opposite to the bottom surface. The light guide plate has a light incident surface and is adjacent to the light emitting cross-section of the lamp reflector, which is disposed by one side of the lamp reflector. The transparent support member is disposed inside the lamp reflector, and leans against the bottom surface of the lamp reflector and the light incident surface of the light guide plate. The light source is disposed inside the transparent support member, such that the light source avoids the damage form the collision by the shifting light guide plate under the protection of the transparent support member.

### CROSS-REFERENCE TO RELATED APPLICATION

This application claims the priority benefit of Taiwan application serial no. 94136285, filed on Oct. 18, 2005. All disclosure of the Taiwan application is incorporated herein by reference.

### BACKGROUND OF THE INVENTION

1. Field of the Invention

The present invention relates to a surface light source apparatus. More particularly, the present invention relates to a surface light source apparatus capable of preventing light sources from damage.

2. Description of Related Art

With the progress in the video technology, liquid crystal displays (LCD) have been extensively used as display screens in consumer electronic products. Because the LCD panel does not emit light, it is necessary to dispose a back light module under the LCD panel to provide a surface light source so that the LCD panel has the display capability. Therefore, the display quality of the LCD is determined by the uniformity and the brightness of the surface light source produced by the back light module. If the arrangement of the inner components of the back light module is not satisfactory, they could easily shift or collide due to shocks during transportation or other factors, which may adversely affect the surface light source produced by the back light module, or even damage the back light module, such that the display quality and product reliability of the LCD are decreased.

Refer to FIG. 1, a partial 3D perspective view of a conventional back light module is shown. A conventional back light module 100 is a side emitting back light module including a cold cathode fluorescence lamp (CCFL) 110, a lamp reflector 120 and a light guide plate (LGP) 130. Wherein, the cold cathode fluorescence lamp 110 is disposed inside the lamp reflector 120 and the light guide plate 130 is disposed beside the lamp reflector 120. In addition, the cold cathode fluorescence lamp 110 emits lights which enter the light guide plate 130 directly or through the reflection of the lamp reflector 120, wherein the light guide plate 130 transforms the light into a surface light source.

Following the above, for fixing the relative location of the lamp reflector 120 and the light guide plate 130, in the conventional technology, a double sided tape 132 is used to adhere between the light guide plate 130 and a frame (not illustrated) to prevent the light guide plate 130 from shifting. However, when the back light module 100 is assembled, as the double sided tape 132 does not attach firmly, it turns into a waved shape to affect the quality of images of the overall module. When the back light module 100 is disassembled for maintenance, as the double sided tape 132 cannot be removed easily and some remnant is still left on the light guide plate 130 or the frame, it causes inconvenience when reassembling the back light module 100. In addition, as the double sided tape 132 does not attach firmly, light leakage is likely to occur where the double sided tape 132 is not attached thoroughly. Furthermore, shocks of the back light module 100 caused by transportation or other factors causes the light guide plate 130 to shift, or even breaks the cold cathode fluorescence lamp 110, due to insufficient adhesion of the double sided tape 132, such that the back light module 100 is damaged. For example, in shock tests, the cold cathode fluorescence lamp 110 can be easily damaged.

Refer to FIG. 2, a partial cross-section view of another conventional back light module is shown. The conventional back light module 200 includes a cold cathode fluorescence lamp 210, a lamp reflector 220 and a light guide plate 230. The cold cathode fluorescence lamp 210 is disposed inside the lamp reflector 220 and the light guide plate 230 is disposed beside the lamp reflector 220. The lamp reflector 220 has two bumps 222 on two inner side walls of the opening of the lamp reflector 220 to prevent the cold cathode fluorescence lamp 210 from damages by the collision of the light guide plate 230 when the light guide plate 230 shifts. However, because the disposition of the bumps 222 on the lamp reflector 220 makes unusual shape of the lamp reflector 220, it is more difficult to mold and fabricate the lamp reflector 220, thus it brings down the yield rate.

### SUMMARY OF THE INVENTION

Accordingly, the present invention is directed to provide a surface light source apparatus capable of preventing the light source from damage.

Based on the above or other objectives, the present invention provides a surface light source apparatus including a lamp reflector, a light guide plate, a transparent support member and a light source. The lamp reflector has a bottom surface and a light emitting cross-section opposite to the bottom surface. The light guide plate having a light incident surface adjacent to the light emitting cross-section of the lamp reflector is disposed by one side of the lamp reflector. The transparent support member is disposed inside the lamp reflector, and leans against the bottom surface of the lamp reflector and the light incident surface of the light guide plate. The light source is disposed inside the transparent support member.

In a preferred embodiment of the present invention, the transparent support member is for example a U-shaped support member, wherein the bottom of the U-shaped support member leans against the bottom surface of the lamp reflector or the light incident surface of the light guide plate.

In a preferred embodiment of the present invention, the transparent support member is for example a ring support member or a frame support member.

In a preferred embodiment of the present invention, a fixing ring is disposed inside the transparent support member, wherein the light source is disposed in the fixing ring.

In a preferred embodiment of the present invention, the material of the transparent support member is for example Polycarbonate (PC) or Polymethyl methacrylate (PMMA).

In a preferred embodiment of the present invention, the light source is for example a cold cathode fluorescence lamp.

In a preferred embodiment of the present invention, the surface light source apparatus further includes, for example, an optical film group disposed on the light guide plate. In addition, the optical film group includes, for example, a diffusion sheet, a brightness enhancement film and a prism film, or at least one of the above.

With the transparent support member leaning against the light incident surface of the light guide plate and the bottom surface of the lamp reflector, the surface light source apparatus of the present invention prevents the light source from damages by the collision of the light guide plate shifting, so as to maintain the high quality of the surface light source apparatus.

### BRIEF DESCRIPTION OF THE DRAWINGS

FIG. 1 is a partial and perspective view of a conventional surface light source apparatus.

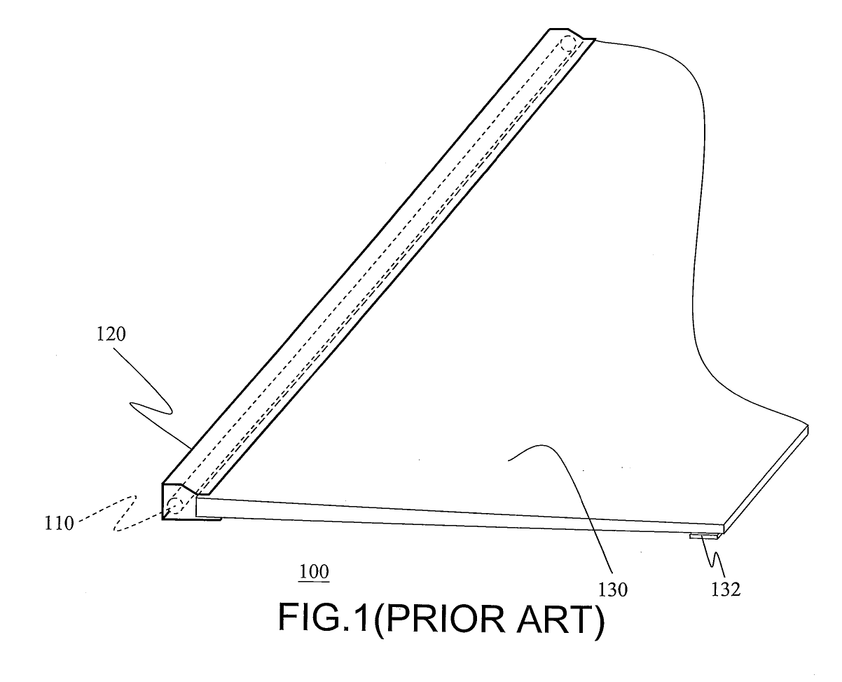

FIG. 2 is a partial cross-section view of another conventional surface light source apparatus.

FIG. 3A is a partial and perspective view of a surface light source apparatus according to a first embodiment of the present invention.

FIG. 3B is a partial cross-section view of the surface light source apparatus in FIG. 3A.

FIG. 4 is a partial and perspective view of a surface light source apparatus according to a second embodiment of the present invention.

FIG. 5 is a partial cross-section view of a surface light source apparatus according to a third embodiment of the present invention.

FIG. 6 is a cross-section view of a surface light source apparatus according to a fourth embodiment of the present invention.

### DESCRIPTION OF THE EMBODIMENTS

In order to make the aforementioned and other objects, features and advantages of the present invention comprehensible, a preferred embodiment accompanied with figures is described in detail below.

### The First Embodiment

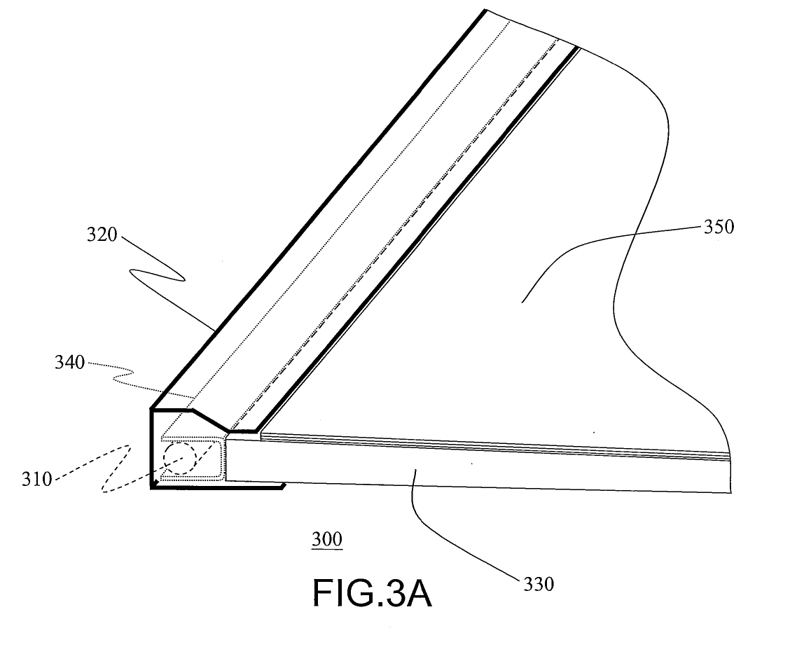

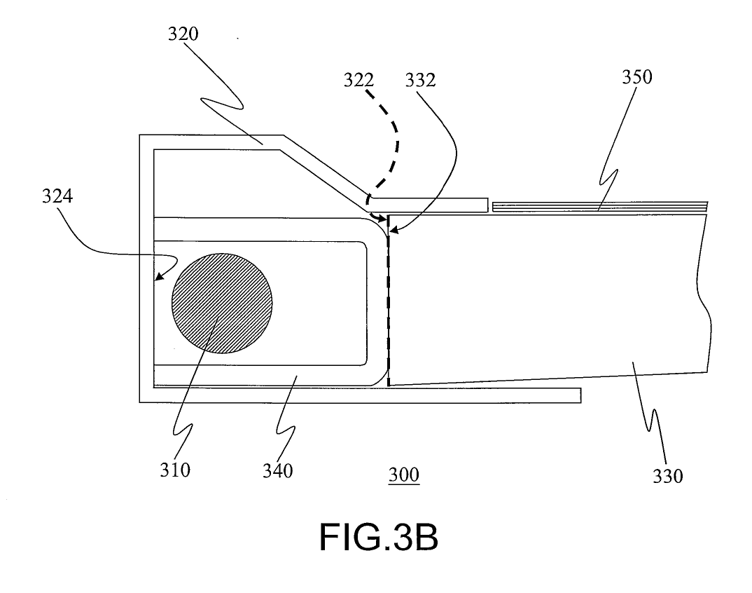

Referring to FIG. 3A and FIG. 3B together, FIG. 3A is a partial and perspective view of a surface light source apparatus according to a first embodiment of the present invention and FIG. 3B is a partial cross-section view of the surface light source apparatus in FIG. 3A. A surface light source apparatus 300 in the present embodiment is used as a LCD back light module or other products requiring a surface light source. The surface light source apparatus 300 includes a light source 310, a lamp reflector 320, a light guide plate 330, and a transparent support member 340. Wherein the light source 310 is disposed inside the transparent support member 340, and the transparent support member 340 is disposed inside the lamp reflector 320. The light guide plate 330 is disposed by one side of the lamp reflector 320. The lamp reflector 320 has a bottom surface 324 and a light emitting cross-section 322 opposite to the bottom surface 324. The light guide plate 330 has a light incident surface 332 adjacent to the light emitting cross-section 322 of the lamp reflector 320. The transparent support member 340 leans against the bottom surface 324 of the lamp reflector 320 and the light incident surface 332 of the light guide plate 330.

In the foregoing surface light source apparatus 300, the light source 310 is for example a cold cathode fluorescence lamp emitting lights which penetrate through the light emitting cross-section 322 of the lamp reflector 320 directly or are reflected by the lamp reflector 320 and to enter the light guide plate 330 through the light incident surface 332 of the light guide plate 330. The light guide plate 330 transforms a linear light into a surface light source.

In the present embodiment, the transparent support member 340 is for example a U-shaped support member, wherein the bottom of the U-shaped support member leans against the light incident surface 332 of the light guide plate 330. However, the transparent support member 340 in the present embodiment also includes a ring support member, a frame support member, or a support member of other shapes, not limited to the U-shaped support member. In addition, the material of the transparent support member 340 has high transparence to prevent the light emitted by the light source 310 from being absorbed by the transparent support member 340 and decreasing the brightness of the surface light source. In detail, the material of the transparent support member 340 includes polycarbonate or polymethyl methacrylate.

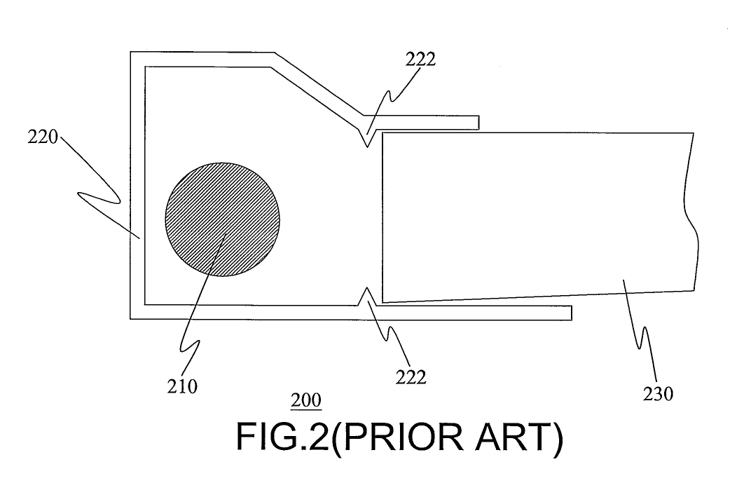

The surface light source apparatus 300 uses the transparent support member 340 as a buffer between the light source 310 and the light guide plate 330. When the surface light source apparatus 300 receives shocks during transportation or other factors to cause the shift of the light guide plate 330, the impact of the light guide plate 330 is received by the transparent support member 340 so as to prevent the light source 310 inside the transparent support member 340 from damages by the collision of the light guide plate 330. The transparent support member 340 is made of high-intensity and shock-proof material. Therefore, the surface light source apparatus 300 as a back light module has higher product reliability. In the present embodiment, a pair of sides of the light guide plate 330 tightly leans against a frame (not illustrated) of the surface light source apparatus 300 and the transparent support member 340 to fix the light guide plate 330. Thus, the disadvantage in the conventional technology that the light guide plate is likely to shift due to the insufficient adhesion of the double sided tape can be overcome, and the problem that the double sided tape cannot be easily removed can be avoided, too. Besides, compared with the lamp reflector 220 (as shown in FIG. 2) in the conventional back light module 200, the structure of the lamp reflector 320 in the present embodiment is simpler and easier to be fabricated, so that the yield of the lamp reflector 320 is higher.

In the first embodiment of the present invention, in order to obtain a better surface light source in the surface light source apparatus 300, a optical film group 350 is disposed on the light guide plate 330, so that the surface light source apparatus 300 provides a surface light source with higher uniformity and brightness. The optical film group 350 includes, for example, a diffusion sheet, a brightness enhancement film and a prism film, or at least one of the above. The optical film group 350 also includes other optical films.

### The Second Embodiment

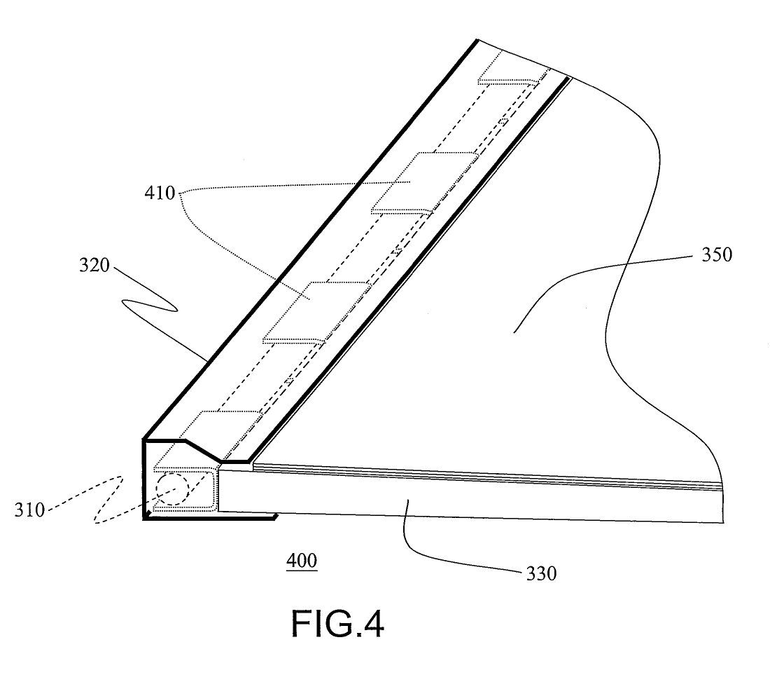

Refer to FIG. 4, a partial and perspective view of a surface light source apparatus according to a second embodiment of the present invention is shown. The surface light source apparatus according to the second embodiment of the present invention is similar to the surface light source apparatus according to the first embodiment, the difference is described below. In the plane light source apparatus 300 according to the first embodiment, the length of the transparent support member 340 is close to the length of the light source 310. In the surface light source apparatus 400 according to the second embodiment, a plurality of transparent support members 410 are used instead of the transparent support member 340. Note that the present invention does not limit the quantity and shape of the transparent support members 410.

### The Third embodiment

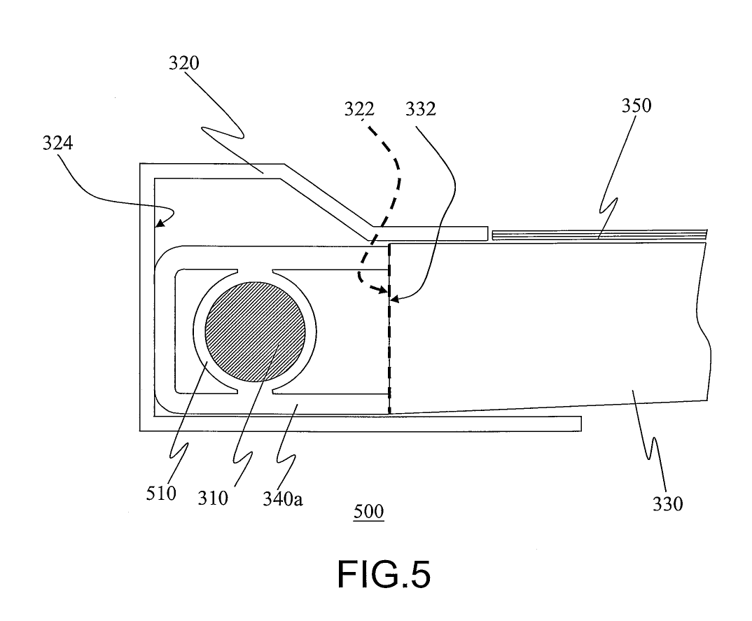

Refer to FIG. 5, a partial cross-section view of a surface light source apparatus of the third embodiment of the present invention is shown. The third embodiment is similar to the first embodiment. The difference is that in the surface light source apparatus 500 according to the third embodiment, the bottom surface of the transparent support member 340a leans against the bottom surface 324 of the lamp reflector 320. In addition, in the present embodiment, the transparent support member 340a further has, for example, a fixing ring 510 and the light source 310 is disposed in the fixing ring 510. The fixing ring 510 is for preventing the light source 310 from shifting.

Note that although in FIG. 5 as an example the fixing ring 510 is formed together with the transparent support member 340a, in the surface light source apparatus of the present invention, the fixing ring 510 and the transparent support member 340a are separate components.

### The Fourth Embodiment

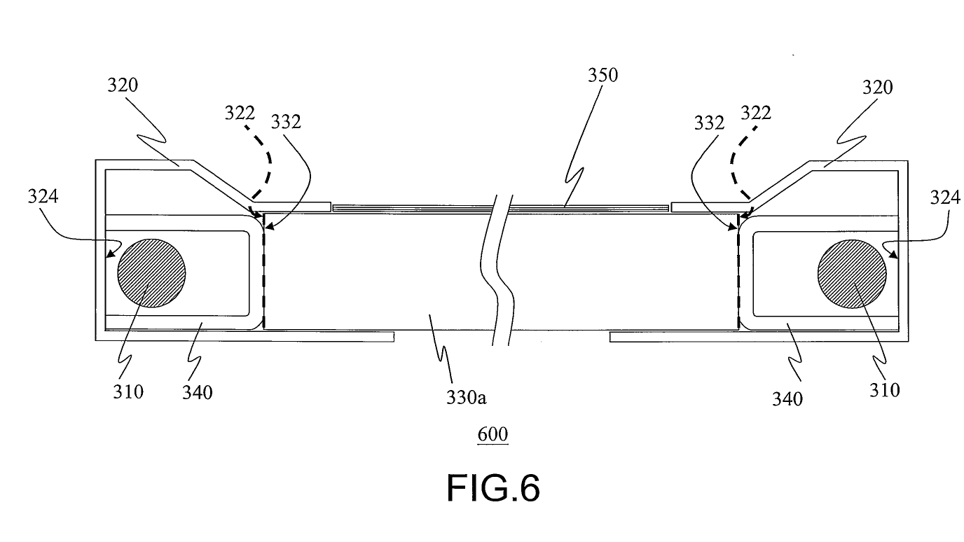

Referring to FIG. 6, a cross-section view of a surface light source apparatus according to the fourth embodiment of the present invention is shown. The fourth embodiment is similar to the first embodiment. The difference is that the surface light source apparatus 600 in the fourth embodiment is a double side emitting surface light source apparatus including two light sources 310 and two transparent support members 340, wherein the light sources 310 are disposed inside the transparent support members 340 so as to avoid the damage from damages by the collision of the light guide plate 330a.

In summary, the surface light source apparatus according to the embodiment of the present invention has at least the following advantages:

1. With the transparent support member leaning against the light incident surface of the light guide plate and the bottom surface of the lamp reflector, the light source is prevented from damages by the collision of the shifting light guide plate, so that the surface light source apparatus of the present invention has higher product reliability.

2. The light guide plate is fixed by the frame and the transparent support member. As a result, the disadvantages in the conventional technology are avoided that the light guide plate is likely to shift due to insufficient adhesion of the double sided tape, and the double sided tape is not easily removed.

3. Instead of the bumps directly formed on the conventional lamp reflector, the transparent support member is a simple structure and disposed inside the lamp reflector, so that the manufacturing difficulties is decreased.

The present invention is disclosed above with its preferred embodiments. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordant with the scope of the following claims and their equivalents.

What is claimed is:

1. A surface light source apparatus, comprising:
a lamp reflector, having a bottom surface and a light emitting cross-section opposite to the bottom surface;
a light guide plate, having a light incident surface adjacent to the light emitting cross-section of the lamp reflector, wherein the light guide plate is disposed by one side of the lamp reflector;
a transparent support member, disposed inside the lamp reflector and leaning against the bottom surface of the lamp reflector and the light incident surface of the light guide plate; and
a light source, disposed inside the transparent support member.

2. The surface light source apparatus as claimed in claim 1, wherein the transparent support member comprises a U-shaped support member.

3. The surface light source apparatus as claimed in claim 2, wherein the bottom of the U-shaped support member leans against the bottom surface of the lamp reflector.

4. The surface light source apparatus as claimed in claim 2, wherein the bottom of the U-shaped support member leans against the light incident surface of the light guide plate.

5. The surface light source apparatus as claimed in claim 1, wherein the transparent support member comprises a ring support member.

6. The surface light source apparatus as claimed in claim 1, wherein the transparent support member comprises a frame support member.

7. The surface light source apparatus as claimed in claim 1, wherein a fixing ring is disposed inside the transparent support member and the light source is disposed in the fixing ring.

8. The surface light source apparatus as claimed in claim 1, wherein the light source comprises a cold cathode fluorescence lamp.
